(19) United States
(12) Patent Application Publication
(10) Pub. No.: US 2022/0222624 A1
(43) Pub. Date: Jul. 14, 2022

(54) SYSTEMS AND METHODS FOR NON-PROFESSIONALS TO MAKE CONSTRUCTION PROJECT SPECIFICATIONS

(71) Applicant: Home Wikii Inc., Gardena, CA (US)

(72) Inventors: Young-Woo NAM, Seoul (KR); Suk-Yeon KIM, Northyork (CA); Ki-Jung NAM, Gardena, CA (US)

(73) Assignee: Home Wikii Inc., Gardena, CA (US)

(21) Appl. No.: 17/146,731

(22) Filed: Jan. 12, 2021

(51) Int. Cl. G06Q 10/10; G06Q 50/16; G06Q 50/08; G06Q 10/00; G06Q 50/00; G06F 3/0482; H04L 12/58

(52) U.S. Cl. CPC G06Q 10/103; G06Q 50/165; G06Q 50/08; H04L 51/046; G06Q 50/01; G06F 3/0482; G06Q 10/20

(57) ABSTRACT

A system and method in which non-professionals can easily make the scope and detailed items of a project are disclosed. The system and method allow a home or building owner, who is not a professional in construction, to do a new construction and/or an addition to existing structure, remodeling, installation, replacement, and repair of a house or building.

### TECHNICAL FIELD

The present invention is about creating construction specifications (hereinafter, “specifications”) for construction such as a new construction and addition, remodeling, installation, replacement, and repair of a house or building (hereinafter, “project”). It relates to a system and method that make it easy for non-professionals (hereinafter, “owner”), such as home or building owners, to create specifications.

### BACKGROUND

When building, remodeling, installing, replacing, or repairing a house or building, owners refer to professionals through yellow pages or service matching websites. After that, the conventional method is that several construction professionals (hereinafter, “professionals”) who have been requested by the owner visit the site to propose construction items and prices, and the owner compares the proposals and prices presented by professionals and then select professionals.

In the conventional method, not only the number of professionals the owner can inquire is small, but the professionals have to visit the site. In addition, there is no means or method for non-professionals to easily create project specifications, so it is almost impossible for owners to present project specifications to professionals. Therefore, the owners have the inconvenience of having to explain the project scope and overview to all of the visiting professionals.

The professionals understand owner's needs through questions and conversations, determine project scope and items, and present specifications and estimates. At this time, the specifications and estimates presented by a plurality of professionals may have different conditions, so it is difficult for the owner to compare the specifications and estimates.

It is not easy for the owner to use a method or means to accurately communicate his or her requirements, and as a result, the information provided by professionals may insufficient or biased, and the professionals selection process may not be satisfactory.

### SUMMARY

The present invention provides a system and method in which non-professionals can easily make the scope and detailed items of a project.

In a preferred embodiment of the present invention, in the new construction and addition, remodeling, installation, replacement, and repair of a house or building, systems and methods that allow home or building owners who are non-professionals in construction to make specifications is presented.

The owner can use it in real time through an app on a mobile phone and selectable types are classified into four groups: new construction and addition, remodeling, installation and replacement, and service, and each group consists of project items. The owner can select one or more of the project items provided by the platform through the app on the mobile device.

When the owner selects a project item, the platform provides a form of the specifications consisting of the cost factors. The owner can complete the specifications by selection and input, and can get help by referring to information and photos provided for each step. In addition, owner can attach photos or drawings of the project site to help professionals create accurate estimates.

The specifications completed by the owner is uploaded to the platform, and is transmitted in real time via mobile to the professionals whose business type and area are matched among the professionals registered as members on the platform.

The professionals can post questions about uploaded specifications through the Q&A window provided by the app, and the postings can be viewed by all professionals along with the owner's answer.

In the system and method according to the present invention, it allows non-professionals to easily create project specifications, and improves the completeness of the specifications through questions from a plurality of professionals and answers from owner. In addition, the owner can compare quotes presented under the same conditions, and completed specifications will be used until project completion.

### Advantageous Effects

The owner can get quotes from more professionals, clarify the project's construction details and items, so that the desired project proposals can be obtained and the possibility of disputes related to the project can be reduced. The professionals can present a quote without visiting the project site, saving time and money.

### BRIEF DESCRIPTION OF DRAWINGS

FIG. 1 shows an UI screen where the owner selects a project item according to an embodiment of the present invention.

FIG. 2 shows an UI screen provided to make the specifications when the owner selects project items from the remodeling project type according to an embodiment of the present invention.

FIG. 3 shows an UI screen provided to make the specifications when the owner selects project items from the installation and replacement project type according to an embodiment of the present invention.

FIG. 4 shows an UI screen provided when the owner inquiries for help information when making the specifications according to an embodiment of the present invention.

FIG. 5 shows an UI screen to attach photos or drawings when the owner makes the specification according to an embodiment of the present invention.

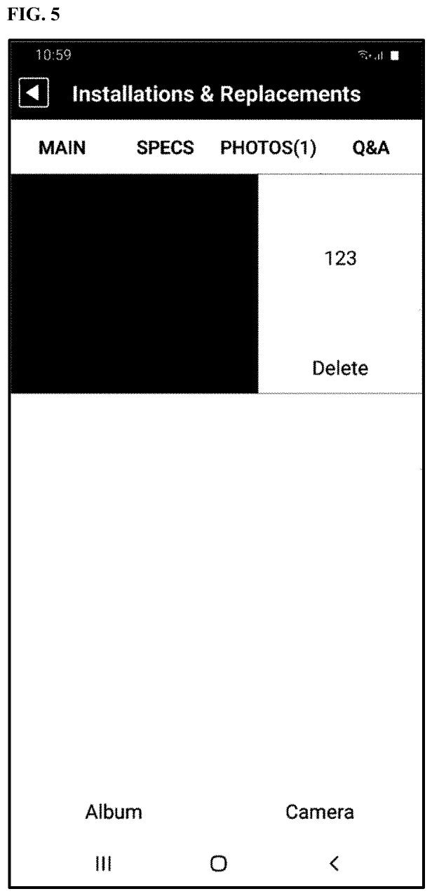

FIG. 6 shows an UI screen provided when the owner and the professionals retrieve the uploaded specifications on the platform according to an embodiment of the present invention.

FIG. 7 shows a Q&A window UI screen where the owner and the professionals can post questions and answers related to the specifications according to an embodiment of the present invention.

### DETAILED DESCRIPTION

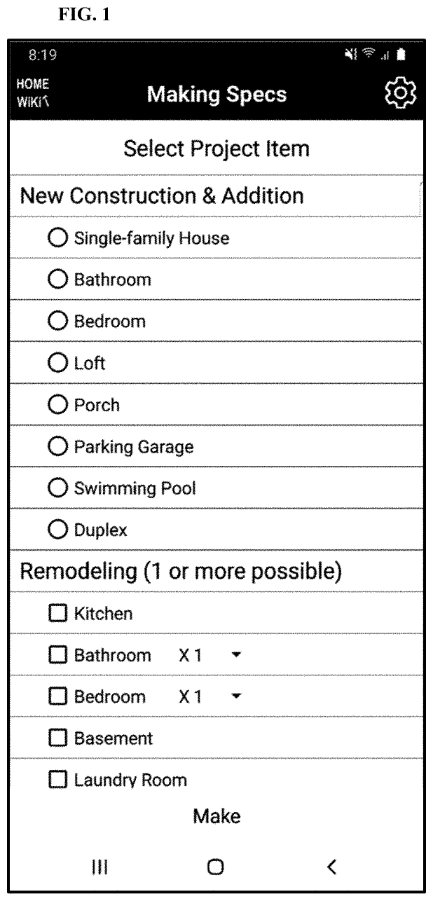

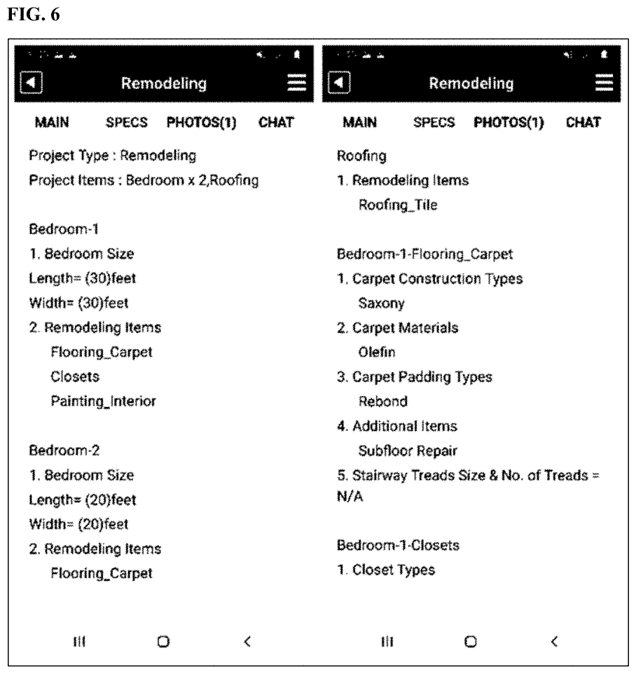

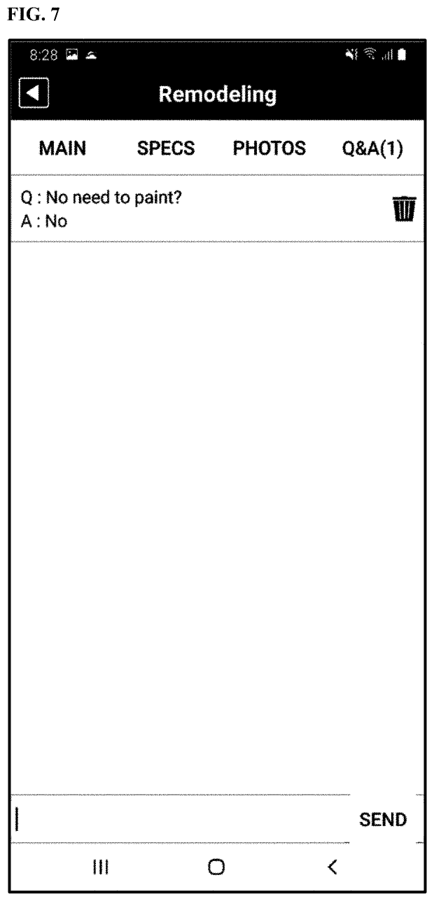

As shown in FIGS. 1 to 4, the owner can make the specifications by himself, and as shown in FIG. 6, the professionals can inquire the specifications uploaded on the platform, and as shown in FIG. 7, the owner and the professionals can ask and answer questions about the specifications, and the contents can be shared by all professionals.

Hereinafter, each procedure will be described in detail.

[Project Types and Project Items]

As shown in FIG. 1, the platform transmits the project types, which are primarily classified as new construction and addition, remodeling, installation and placement, and service, to the owner's mobile phone.

Each project type consists of project items. Project items can be added, changed, or deleted.

[Structure of the Specifications]

It is the most essential part of the present invention.

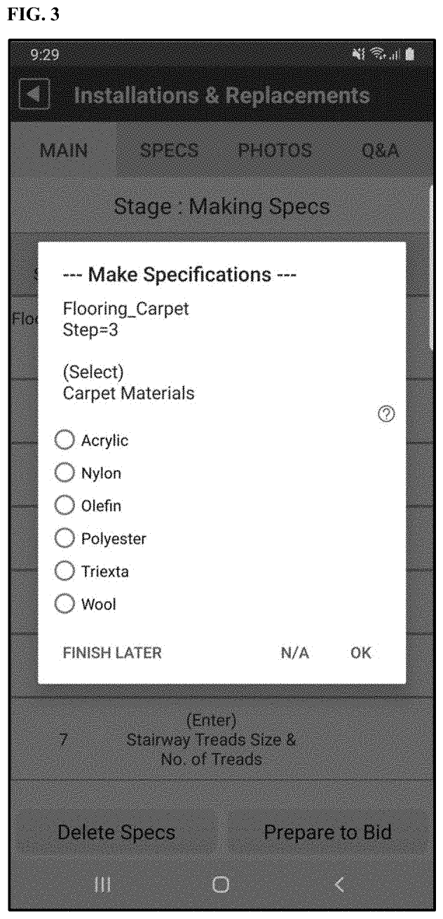

Making the specifications of the project item corresponding to the installation and replacement project type consists of selecting the type of material required for the project as shown in FIG. 3, and is configured differently for each project item. Owners can make the specifications by selecting the type of material and entering the size of the project according to the form and instructions provided by the platform.

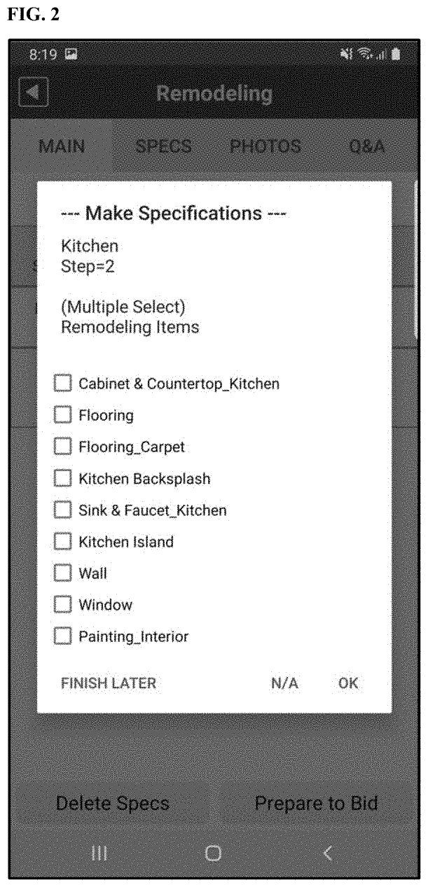

Making the specifications of the project item corresponding to the remodeling project type allows the owner to first select the remodeling item as shown in FIG. 2, and the subsequent steps consist of the procedure and method of making the specifications of the installation and replacement project type. Each project item corresponding to the remodeling project type consists of two or more installation and replacement type project items.

[Use of the Information Window]

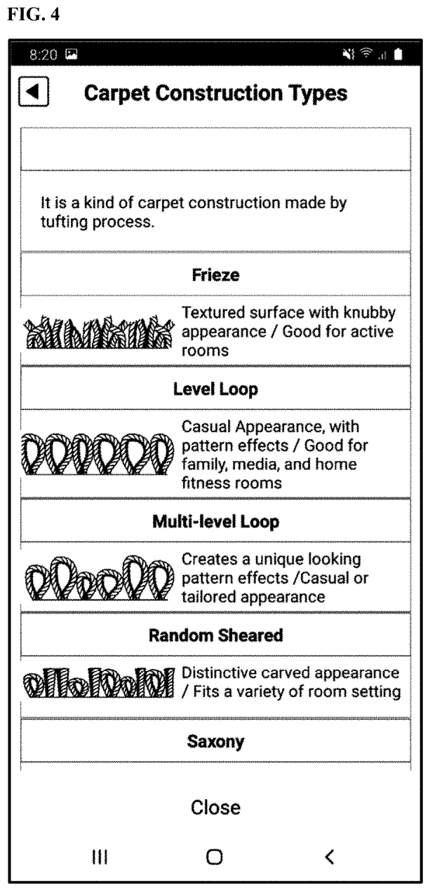

In completing the specifications, the owner can inquire information necessary for selection as shown in FIG. 4.

[Use of Q&a Window]

The professionals can inquire the specifications uploaded on the platform by the owner as shown in FIG. 6, and if there is a question, it can be posted on the Q&A window as shown in FIG. 7. The contents posted in the Q&A is open to both the owner and the professionals. The professionals can make the quotation based on the specifications uploaded on the platform and the contents posted on the Q&A.

[Inspection]

The inspection is conducted based on the uploaded specifications.

What is claimed is:

1. A method performed by a platform server to support a project including at least one of construction, remodeling, installation, replacement, and repair of houses or buildings, comprising:
providing a selectable project items to the mobile phone of the owner of the above-mentioned house or building;
receiving a project item selected by the owner from the above-mentioned owner's mobile phone;
transmitting a specification form corresponding to the above-received project item to the above-mentioned owner's mobile phone;
receiving the completed specifications from the above-mentioned owner's mobile phone;
compiling only the results selected by the above-mentioned owner in the above-received specification form;
storing the above-compiled specifications and transmitting it to one or more professionals' mobile phone.

2. The method of claim 1, wherein making the specifications comprising:
attaching a picture or drawing of the site by the above-mentioned owner using a mobile phone.

3. The method of claim 1, wherein making the specifications comprising:
attaching an additional photo or drawing by the above-mentioned owner even after the specifications is uploaded on the platform.

4. The method of claim 1, wherein making the specifications comprising:
opening a Q&A bulletin board after transmitting the specifications to the professionals; and
posting questions and answers from the professionals and the owner on the above-mentioned Q&A bulletin board.
